(19) United States
(12) Patent Application Publication
(10) Pub. No.: US 2007/0247406 A1
(43) Pub. Date: Oct. 25, 2007

(54) Method and Apparatus for Updating Sub-Pictures in a Bi-Stable Electronic Reading Device

(76) Inventors: Guofu Zhou, Best (NL); Jan Van De Kamer, Heerlen (NL)

Correspondence Address: PHILIPS INTELLECTUAL PROPERTY & STANDARDS, P.O. BOX 3001, BRIARCLIFF MANOR, NY, 10510, US

(21) Appl. No.: 10/569,715

(22) PCT Filed: Aug. 24, 2004
(86) PCT No.: PCT/IB04/51552

§ 371 Date: Mar. 20, 2007

Related U.S. Application Data
(60) Provisional application No. 60/498,026, filed on Aug. 27, 2003.

(51) Int. Cl. G09G 3/34

(52) U.S. Cl. 345/89

(57) ABSTRACT

Image quality is improved in an electronic reading device (300, 400), such as an electronic book using a bi-stable electrophoretic display, by determining a position to display a sub-picture (900) over a background picture (800, 810) so that like colors do not overlap. This avoids having a noticeable contrast between the color of the background picture, which may have faded since the background was displayed, and the color of the sub-picture. In another embodiment, a transition region (1310, 1320) is provided between the sub-picture (1350) and the background picture (1300) using an intermediate color, or a dithered or greyscale pattern. The background picture and sub-picture may include text and/or images.

The invention relates generally to electronic reading devices such as electronic books and electronic newspapers and, more particularly, to a method and apparatus for displaying a sub-picture over a background picture by positioning the sub-picture to mask the effects of color drift in the background.

Recent technological advances have provided “user friendly” electronic reading devices such as e-books that open up many opportunities. For example, electrophoretic displays hold much promise. Such displays have an intrinsic memory behavior and are able to hold an image for a relatively long time without power consumption. Power is consumed only when the display needs to be refreshed or updated with new information. So, the power consumption in such displays is very low, suitable for applications for portable e-reading devices like e-books and e-newspaper. Electrophoresis refers to movement of charged particles in an applied electric field. When electrophoresis occurs in a liquid, the particles move with a velocity determined primarily by the viscous drag experienced by the particles, their charge (either permanent or induced), the dielectric properties of the liquid, and the magnitude of the applied field. An electrophoretic display is a type of bi-stable display, which is a display that substantially holds an image without consuming power after an image update.

For example, international patent application WO 99/53373, published Apr. 9, 1999, by E Ink Corporation, Cambridge, Mass., US, and entitled Full Color Reflective Display With Multichromatic Sub-Pixels, describes such a display device. WO 99/53373 discusses an electronic ink display having two substrates. One is transparent, and the other is provided with electrodes arranged in rows and columns. A display element or pixel is associated with an intersection of a row electrode and column electrode. The display element is coupled to the column electrode using a thin film transistor (TFT), the gate of which is coupled to the row electrode. This arrangement of display elements, TFT transistors, and row and column electrodes together forms an active matrix. Furthermore, the display element comprises a pixel electrode. A row driver selects a row of display elements, and a column driver supplies a data signal to the selected row of display elements via the column electrodes and the TFT transistors. The data signals correspond to graphic data to be displayed, such as text or figures.

The electronic ink is provided between the pixel electrode and a common electrode on the transparent substrate. The electronic ink comprises multiple microcapsules of about 10 to 50 microns in diameter. In one approach, each microcapsule has positively charged white particles and negatively charged black particles suspended in a liquid carrier medium or fluid. When a positive voltage is applied to the pixel electrode, the white particles move to a side of the microcapsule directed to the transparent substrate and a viewer will see a white display element. At the same time, the black particles move to the pixel electrode at the opposite side of the microcapsule where they are hidden from the viewer. By applying a negative voltage to the pixel electrode, the black particles move to the common electrode at the side of the microcapsule directed to the transparent substrate and the display element appears dark to the viewer. At the same time, the white particles move to the pixel electrode at the opposite side of the microcapsule where they are hidden from the viewer. When the voltage is removed, the display device remains in the acquired state and thus exhibits a bi-stable character. In another approach, particles are provided in a dyed liquid. For example, black particles may be provided in a white liquid, or white particles may be provided in a black liquid. Or, other colored particles may be provided in different colored liquids, e.g., white particles in green liquid.

Other fluids such as air may also be used in the medium in which the charged black and white particles move around in an electric field (e.g., Bridgestone SID2003—Symposium on Information Displays. May 18-23, 2003,—digest 20.3). Colored particles may also be used.

To form an electronic display, the electronic ink may be printed onto a sheet of plastic film that is laminated to a layer of circuitry. The circuitry forms a pattern of pixels that can then be controlled by a display driver. Since the microcapsules are suspended in a liquid carrier medium, they can be printed using existing screen-printing processes onto virtually any surface, including glass, plastic, fabric and even paper. Moreover, the use of flexible sheets allows the design of electronic reading devices that approximate the appearance of a conventional book.

In order to further reduce power consumption, a sub-picture may be displayed against an existing background picture by defining a partial display window rather than updating the entire display screen. For some applications, a sub-picture needs to be displayed in an already existing greyscale or color picture background. This sub-picture can be a black and white, greyscale or color picture. Although the E-ink display is bi-stable, the brightness of various grey states, for example, will drift in time towards a middle grey level. When the sub-picture with the same nominal, pre-drift grey level is updated close to the existing picture, a difference will be visible to the users, resulting in poor performance. This problem is present for both partial display updates and full image updates. When a pixel does not change color, the controller does not activate/refresh it, although we can do this by filling in data in the look-up-table (LUT). For example, an existing white background will tend to become grey over time. If a sub-picture with a white background is displayed over such a background, the change in color will be noticeable. It would therefore be desirable to mask the effect of color drift in a background image when a sub-picture is displayed over a background picture.

The present invention addresses the above and other issues.

In one aspect of the invention, a method for displaying a sub-picture over a background picture on an electronic reading device is provided. The method includes determining a visual characteristic of at least a portion of the background picture, determining a visual characteristic of at least a portion of the sub-picture, and determining a position for displaying the sub-picture so that the at least a portion of the background picture and the at least a portion of the sub-picture are separated when the visual characteristics thereof differ by less than a threshold difference. The visual characteristic may be a grey scale level or color level, for example.

In a further aspect of the invention, a method for displaying a sub-picture over a background picture on an electronic reading device includes determining a visual characteristic of at least a portion of the background picture, determining a visual characteristic of at least a portion of the sub-picture, and displaying the at least a portion of the sub-picture over the at least a portion of the background picture with a transition region therebetween in accordance with the visual characteristics thereof.

Related electronic reading devices and computer program products are also provided.

In the drawings:

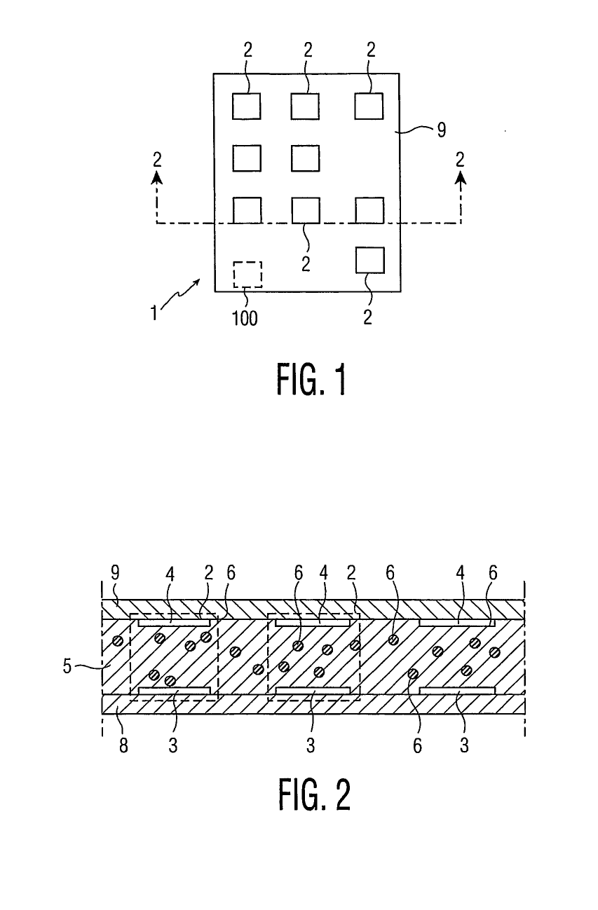

FIG. 1 shows diagramatically a front view of an embodiment of a portion of a display screen of an electronic reading device;

FIG. 2 shows diagramatically a cross-sectional view along 2-2 in FIG. 1;

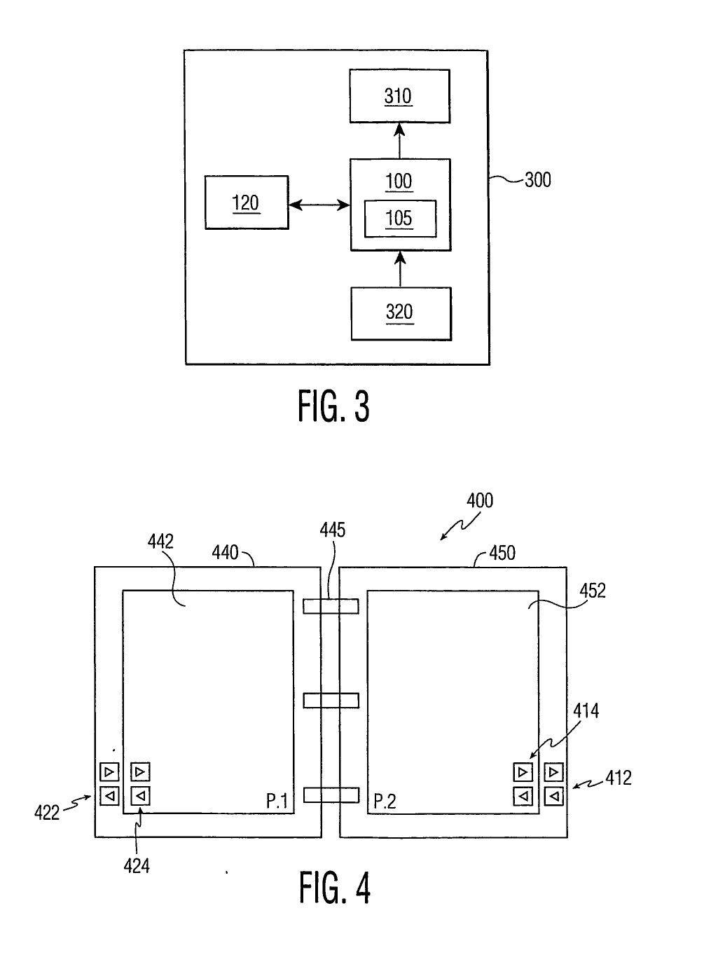

FIG. 3 shows diagramatically an overview of an electronic reading device;

FIG. 4 shows diagramatically two display screens with respective display regions;

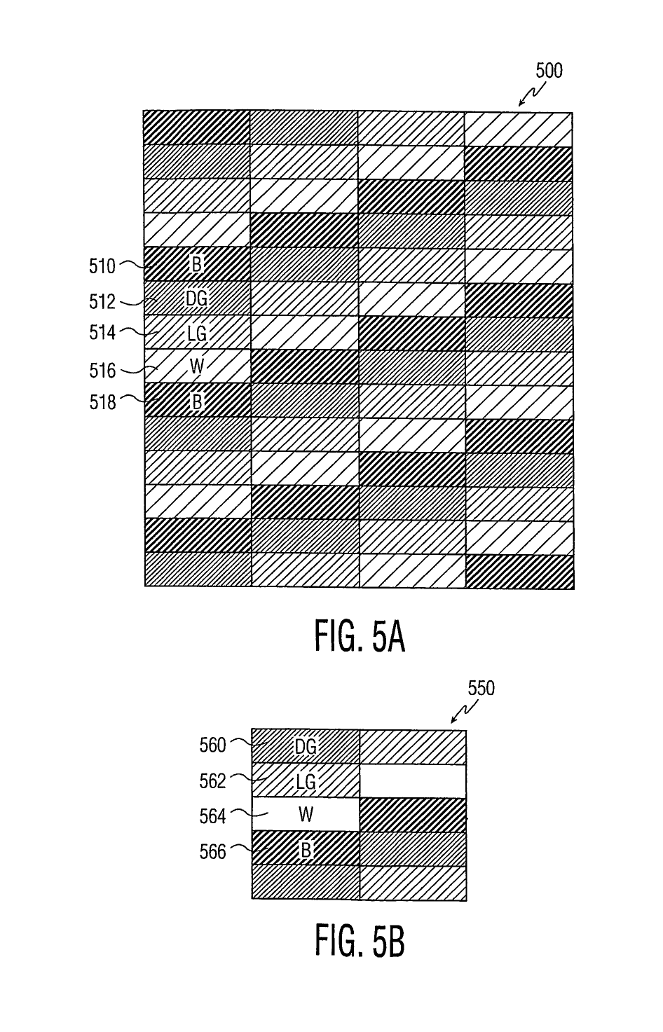

FIG. 5A shows an example of a background picture;

FIG. 5B shows an example of a sub-picture to be displayed over the background picture of FIG. 5A;

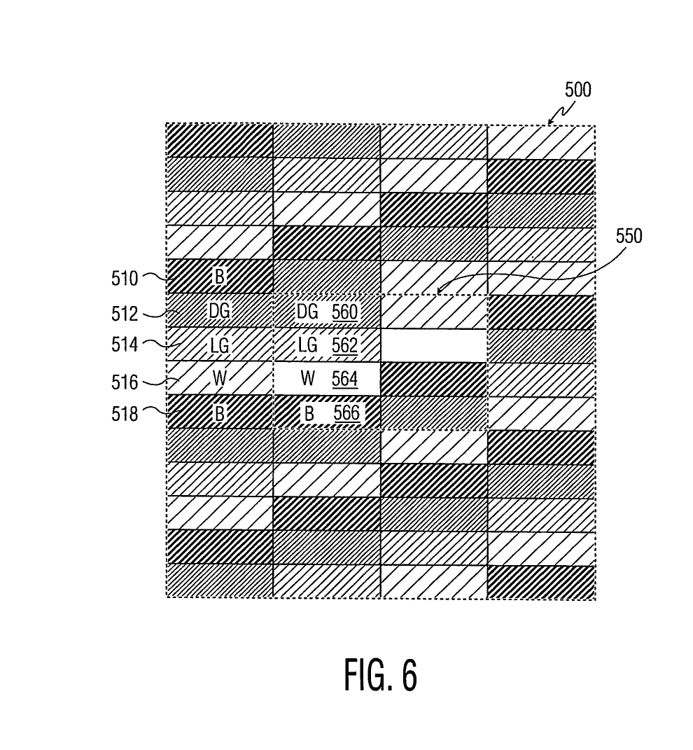

FIG. 6 shows an example of a sub-picture displayed over a background picture without considering the visual difference between the same greyscale levels;

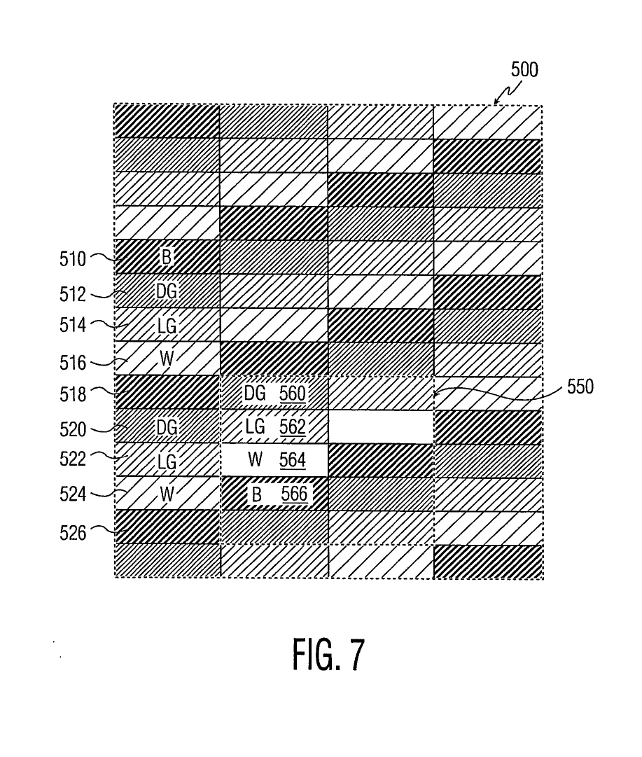

FIG. 7 shows an example of a sub-picture displayed over a background picture with consideration of the visual difference between the same greyscale levels;

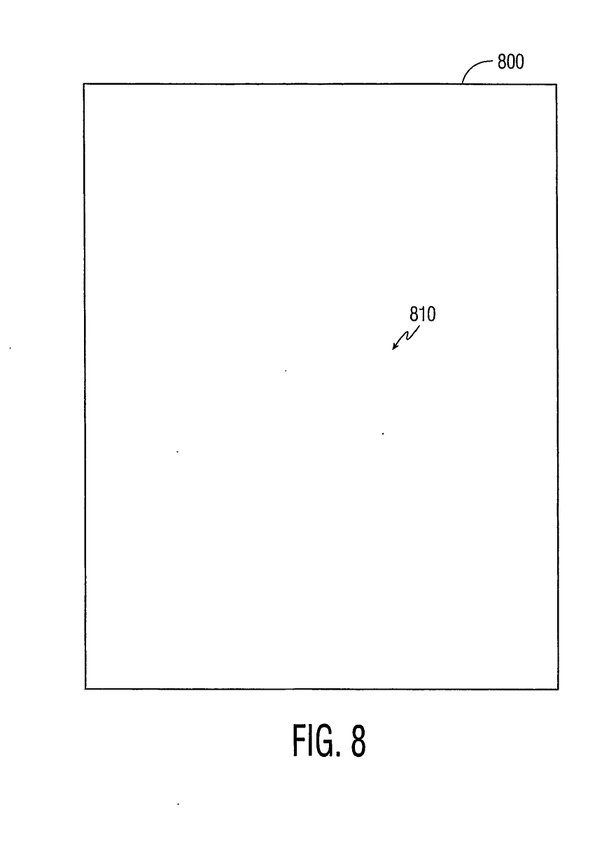

FIG. 8 shows an example background picture with an initial black color level;

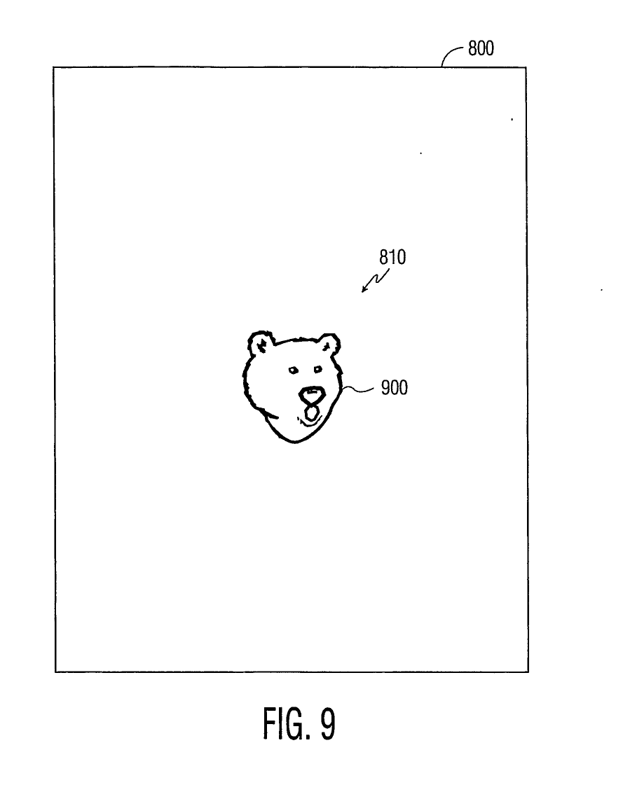

FIG. 9 shows an example background picture with a faded black color level and an overlapping sub-picture with an initial black color level;

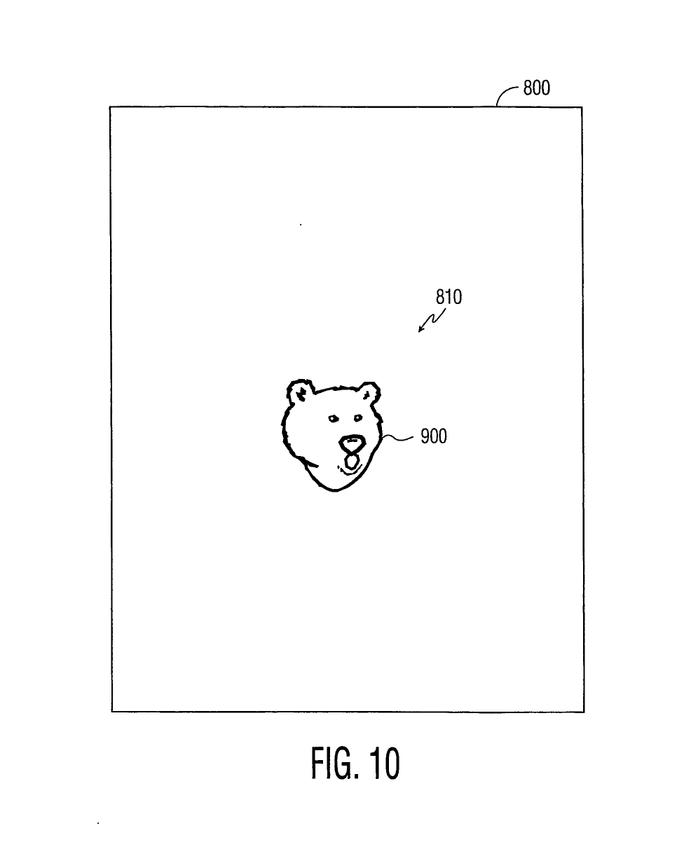

FIG. 10 shows an example background picture with a faded black color level and a non-overlapping sub-picture with an initial black color level;

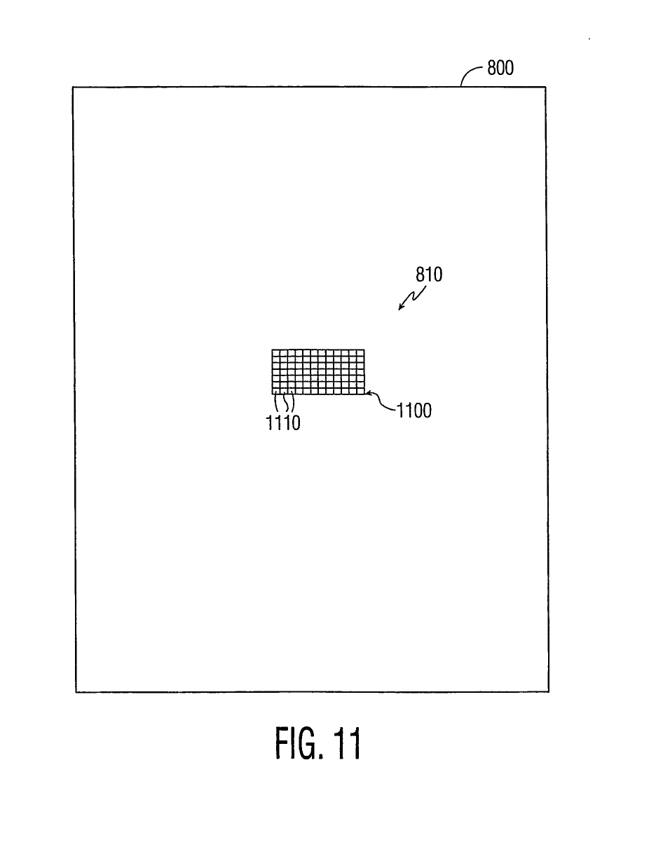

FIG. 11 shows an example background picture with a faded black color level and a grid of regions to be examined to locate a region whose color level differs from the initial black color level of the sub-picture;

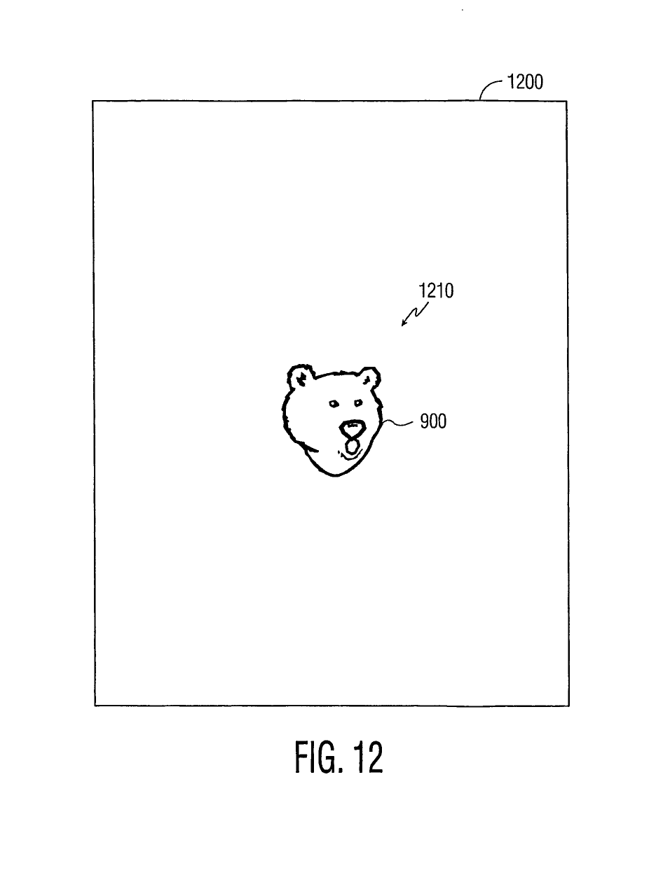

FIG. 12 shows an example background picture with a faded light grey color level and an overlapping sub-picture with an initial black color level;

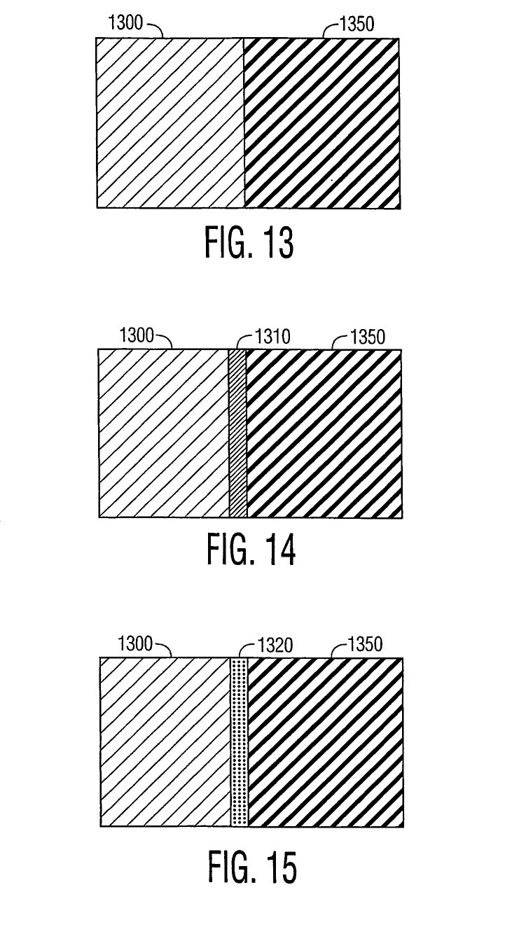

FIG. 13 illustrates an example background picture region with a faded black color level and an overlapping sub-picture region with an initial black color level;

FIG. 14 illustrates a transition region with an intermediate color between a background picture region with a faded black color level and an overlapping sub-picture region with an initial black color level;

FIG. 15 illustrates a transition region with a dithering or grey scaling pattern between a background picture region with a faded black color level and an overlapping sub-picture region with an initial black color level; and

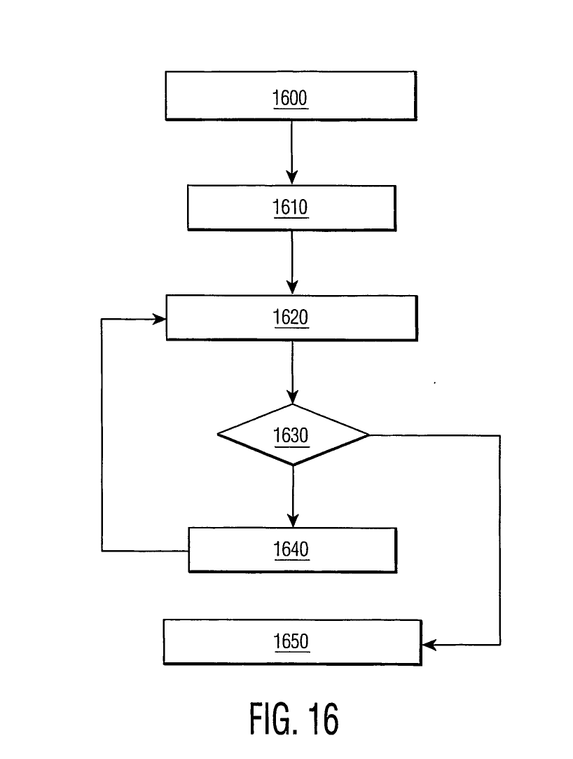

FIG. 16 illustrates a method for positioning a sub-picture over a background picture.

In all the Figures, corresponding parts are referenced by the same reference numerals.

FIGS. 1 and 2 show the embodiment of a portion of a display panel 1 of an electronic reading device having a first substrate 8, a second opposed substrate 9 and a plurality of picture elements 2. The picture elements 2 may be arranged along substantially straight lines in a two-dimensional structure. The picture elements 2 are shown spaced apart from one another for clarity, but in practice, the picture elements 2 are very close to one another so as to form a continuous image. Moreover, only a portion of a full display screen is shown. Other arrangements of the picture elements are possible, such as a honeycomb arrangement. An electrophoretic medium 5 having charged particles 6 is present between the substrates 8 and 9. A first electrode 3 and second electrode 4 are associated with each picture element 2. The electrodes 3 and 4 are able to receive a potential difference. In FIG. 2, for each picture element 2, the first substrate has a first electrode 3 and the second substrate 9 has a second electrode 4. The charged particles 6 are able to occupy positions near either of the electrodes 3 and 4 or intermediate to them. Each picture element 2 has an appearance determined by the position of the charged particles 6 between the electrodes 3 and 4. Electrophoretic media 5 are known per se, e.g., from U.S. Pat. No. 5,961,804, 6,120,839, and 6,130,774 and can be obtained, for instance, from E Ink Corporation.

As an example, the electrophoretic medium 5 may contain negatively charged black particles 6 in a white fluid. When the charged particles 6 are near the first electrode 3 due to a potential difference of, e.g., +15 Volts, the appearance of the picture elements 2 is white. When the charged particles 6 are near the second electrode 4 due to a potential difference of opposite polarity, e.g., −15 Volts, the appearance of the picture elements 2 is black. When the charged particles 6 are between the electrodes 3 and 4, the picture element has an intermediate appearance such as a grey level between black and white. A drive control 100 controls the potential difference of each picture element 2 to create a desired picture, e.g. images and/or text, in a full display screen. The full display screen is made up of numerous picture elements that correspond to pixels in a display.

FIG. 3 shows diagramatically an overview of an electronic reading device. The electronic reading device 300 includes the control 100, including an addressing circuit 105. The control 100 controls the one or more display screens 310, such as electrophoretic screens, to cause desired text or images to be displayed. For example, the control 100 may provide voltage waveforms to the different pixels in the display screen 310. The addressing circuit provides information for addressing specific pixels, such as row and column, to cause the desired image or text to be displayed. As described further below, the control 100 causes successive pages to be displayed starting on different rows and/or columns. The image or text data may be stored in a memory 120. One example is the Philips Electronics small form factor optical (SFFO) disk system. The control 100 may be responsive to a user-activated software or hardware button 320 that initiates a user command such as a next page command or previous page command.

The control 100 may be part of a computer that executes any type of computer code devices, such as software, firmware, micro code or the like, to achieve the functionality described herein. Accordingly, a computer program product comprising such computer code devices may be provided in a manner apparent to those skilled in the art. The control 100 may have logic for periodically providing a forced reset of a display region of an electronic book, e.g., after every x pages are displayed, after every y minutes, e.g., ten minutes, when the electronic reading device is first turned on, and/or when the brightness deviation is larger than a value such as 3% reflection. For automatic resets, an acceptable frequency can be determined empirically based on the lowest frequency that results in acceptable image quality. Also, the reset can be initiated manually by the user via a function button or other interface device, e.g., when the user starts to read the electronic reading device, or when the image quality drops to an unacceptable level. The required reset frequency is reduced with the invention, e.g., by 80% or more, by introducing the option of sub-picture update.

The invention may be used with any type of electronic reading device. FIG. 4 illustrates one possible example of an electronic reading device 400 having two separate display screens. Specifically, a first display region 442 is provided on a first screen 440, and a second display region 452 is provided on a second screen 450. The screens 440 and 450 may be connected by a binding 445 that allows the screens to be folded flat against each other, or opened up and laid flat on a surface. This arrangement is desirable since it closely replicates the experience of reading a conventional book.

Various user interface devices may be provided to allow the user to initiate page forward, page backward commands and the like. For example, the first region 442 may include on-screen buttons 424 that can be activated using a mouse or other pointing device, a touch activation, PDA pen, or other known technique, to navigate among the pages of the electronic reading device. In addition to page forward and page backward commands, a capability may be provided to scroll up or down in the same page. Hardware buttons 422 may be provided alternatively, or additionally, to allow the user to provide page forward and page backward commands. The second region 452 may also include on-screen buttons 414 and/or hardware buttons 412. Note that the frame 405 around the first and second display regions 442, 452 is not required as the display regions may be frameless. Other interfaces, such as a voice command interface, may be used as well. Note that the buttons 412, 414; 422, 424 are not required for both display regions. That is, a single set of page forward and page backward buttons may be provided. Or, a single button or other device, such as a rocker switch, may be actuated to provide both page forward and page backward commands. A function button or other interface device can also be provided to allow the user to manually initiate a reset.

In other possible designs, an electronic book has a single display screen with a single display region that displays one page at a time. Or, a single display screen may be partitioned into or two or more display regions arranged, e.g., horizontally or vertically. In any case, the invention can be used with each display region to reduce image retention effects.

Furthermore, when multiple display regions are used, successive pages can be displayed in any desired order. For example, in FIG. 4, a first page can be displayed on the display region 442, while a second page is displayed on the display region 452. When the user requests to view the next page, a third page may be displayed in the first display region 442 in place of the first page while the second page remains displayed in the second display region 452. Similarly, a fourth page may be displayed in the second display region 452, and so forth. In another approach, when the user requests to view the next page, both display regions are updated so that the third page is displayed in the first display region 442 in place of the first page, and the fourth page is displayed in the second display region 452 in place of the second page. When a single display region is used, a first page may be displayed, then a second page overwrites the first page, and so forth, when the user enters a next page command. The process can work in reverse for page back commands. Moreover, the process is equally applicable to languages in which text is read from right to left, such as Hebrew, as well as to languages such as Chinese in which text is read column-wise rather than row-wise.

Additionally, note that the entire page need not be displayed on the display region. A portion of the page may be displayed and a scrolling capability provided to allow the user to scroll up, down, left or right to read other portions of the page. A magnification and reduction capability may be provided to allow the user to change the size of the text or images. This may be desirable for users with reduced vision, for example.

FIG. 5A shows an example of a background picture, and FIG. 5B shows an example of a sub-picture to be displayed over the background picture of FIG. 5A. The background picture 500 includes a number of regions, such as regions 510, 512, 514, 516 and 518. The regions are shown as being uniform rectangles for simplicity, although other shapes may be used. Each region encompasses a number of pixels. The sub-picture 550 includes regions 560, 562, 564 and 566. As an example, both the background picture 500 and sub-picture 550 uses a grey scale with four grey levels: black (B), dark grey (DG), light grey (LG) and white (W). Since the background picture was previously updated, e.g., displayed on a display device, the white and light grey state have since become less bright than directly after update and the dark grey and black state have drifted to a less dark state. That is, the colors have faded in the direction of 50% grey. When the sub-picture 550 is displayed over the background picture 500 without considering the fact that the background picture has faded, a poor visual effect may be observed when a particular unfaded color is located next to a faded version of the color.

For example, as shown in FIG. 6, the sub-picture 550 is positioned so that its dark grey region 560 is next to the faded dark grey region 512 of the background picture 500. Similarly, the light grey region 562 of the sub-picture 550 is next to the faded light grey region 514 of the background picture 500, the white region 564 of the sub-picture 550 is next to the faded white region 516 of the background picture 500, and the black region 566 of the sub-picture 550 is next to the faded black region 518 of the background picture 500.

In accordance with the invention, the visual effect can be significantly improved by separating picture regions having unfaded and faded versions of the same or similar color. For example, as shown in FIG. 7, the sub-picture 550 may be located in a position on the background picture 500 such that the dark grey region 560 of the sub-picture 550 is separated from a faded dark grey region 520 of the background picture 500, the light grey region 562 of the sub-picture 550 is separated from a faded light grey region 522 of the background picture 500, the white region 564 of the sub-picture 550 is separated from a faded white region 524 of the background picture 500, and the black region 566 of the sub-picture 550 is separated from a faded black region 526 of the background picture 500. Thus, the faded and unfaded versions of all four grey levels are separated from one another.

Generally, the invention provides a technique for updating black and white, greyscale or color sub-pictures in an electronic reading device, such as a bi-stable device based on the E-ink display. The sub-picture can include any text and/or graphics that is desired to be displayed over an existing background. This occurs in many practical situations. For example, an electronic dictionary or encyclopedia may provide text that describes a subject. A related image may be displayed as a sub-picture near the existing text automatically or responsive to a user input. In this case, the background picture includes the text and perhaps a blank region of the display. The challenge, therefore, is to select a location for displaying the sub-picture over the background picture. The choice of positions may be constrained by other text or images on the display.

In particular, the location of the partial window, or sub-picture, may be defined by (x, y) coordinates on the display screen. The selected location depends on the information of both the existing background picture and the new sub-picture. The selected location should eliminate the probability that the area with the same or similar (nominal) grey level or color level of the sub-picture is close to that of the existing picture. That is, the same (nominal) grey or color area between new and old pictures should be intentionally separated. The amount of separation can be determined as a fixed dimension, or based on factors such as the size of features, such as text in the background picture, and the size of the sub-picture, the display screen size and the like. For example, a relatively small sub-picture that is displayed next to relatively small text in the background may be separated a smaller distance than for a large sub-picture next to large text. Generally, the goal is avoid or minimize the perception by the viewer of fading on the display device.

For example, consider the background picture 800 with text feature 810 of FIG. 8. The text feature may be part of a dictionary or encyclopedia software application running on the electronic reading device that has an entry for the subject “Bear.” After the text 810 is displayed, the associated initial visual characteristic, such as its color, e.g., black, will fade over time due to the drift characteristic of the bi-stable electronic reading device. Referring to FIG. 9, a sub-picture 900, which is an image of a bear, is displayed over the background 800. The sub-picture may be displayed automatically after the associated text has been displayed, or the user may enter a command for displaying the sub-picture 900 after reading the text 810, for example. Various on-screen user interface devices may be employed for this purpose, such as a button for “display image.” Note that the background 800 is not updated when the sub-picture 900 is displayed since this would consume power unnecessarily. The information provided by the sub-picture 900, e.g., a picture of a bear, is associated with the information provided by the background 800, e.g., the text “Bear.” Additionally, at this time the text 810 has faded to dark grey, e.g., faded black, level. Assume also that the sub-picture 900 has an initial visual characteristic, which is its color, e.g., black, at least at regions of the bear that are near the text 810.

In this case, a portion of the sub-picture 900 is overlapping with the text 810. This is undesirable since a black portion of the sub-picture 900, overlaps a faded black portion of the background. Specifically, the left ear of the bear overlaps part of the bottom of the letter “e”, and the right ear overlaps part of the bottom of the letter “a”. The viewer can therefore quickly detect that the background has faded since the fading of the text 810 of the background picture 800 is accentuated by the proximity of the sub-picture 900. Accordingly, the situation of FIG. 9 should be avoided. Note that the degree of fading of the text 810 is exaggerated for clarity. In practice, the fading is typically subtler but still detectable by the viewer.

FIG. 10 illustrates the sub-picture 900 displayed over the background 800 so that like-colored regions of the sub-picture and background 800 are separated. In particular, a space is provided between the sub-picture 900 from the background text 810, which, in this example, is a contrasting white color. Note that the white color will fade over time as well by darkening. This approach takes advantage of the fact it is more difficult for humans to distinguish slightly different colors when they are separated than when they are overlapping, e.g., adjacent.

FIG. 11 illustrates candidate regions for determining a location for displaying a sub-picture so that like colors are separated. FIG. 16 illustrates a related method. First, candidate regions may be determined for displaying the sub-picture, such as regions in the area 1100 (FIG. 16, block 1600). The candidate locations may be decided based on features of the background picture, for example, such as the text 810. As an example, the candidate locations may extend a certain distance below the text 810 and centered with respect to the text 810. The area 1100 includes a number of regions 1110 arranged in a grid or other pattern. The regions can be uniform or have different sizes and shapes. The regions may each encompass a number of pixels. The regions of the area 1100 may comprise an area that is less than that of the sub-picture. Or, the sub-picture may fit within a single region. For a given region 1110 (FIG. 16, block 1610), a determination is made as to whether displaying the sub-picture with reference to that region will result in like colors overlapping. For example, the reference region may define the upper left most portion of a sub-picture, while other portions of the sub-picture extend in other regions.

For each respective region, the color or greyscale level of the background picture that is present may be compared to the color or greyscale level of the sub-picture (FIG. 16, block 1620). Comparisons need not be made for regions that do not include a portion of the sub-picture. The control 100 (FIG. 3) can perform this task by accessing data stored in the memory 120 that was used to display the background picture 800, and that will be used to display the sub-picture. If the compared color or greyscale levels are close for any of the regions, e.g., the same or within a predetermined threshold, the particular reference region is not a good choice, and a next region is selected as a reference (FIG. 16, blocks 1630 and 1640). The comparisons are performed again until a reference region that does not result in overlapping of like colors in any region is located. The regions in the area 1100 may be traversed in this procedure using any desired order, e.g., from left to right and top to bottom. Once a reference region is found that does not result in overlapping of like colors in any region, the sub-picture 900 is displayed over the background picture 800 in a location determined by the reference region (FIG. 16, block 1650).

In a further approach, the degree of overlapping of like colors is quantified so that some overlapping is allowed. The extent of overlapping and the closeness of the colors may be factored into such a decision. The size of the sub-picture 900 and the feature, e.g., text 810, in the background picture 800 that is overlapped may also be considered.

Regarding the predetermined threshold, with a four level or two-bit grey scale which includes black, dark grey, light grey and white, the colors are sufficiently far apart that the sub-picture may be precluded from being displayed when overlapping color levels are the same. In this case, the threshold is therefore a zero difference. For a 16-level or four bit grey scale, the threshold may be a given number of levels, e.g., three levels. A 256-level or eight bit grey scale may also be used. The optimum threshold may be determined experimentally based on testing of viewers.

Moreover, instead of comparing the initial color levels of the sub-picture 900 and background picture 800, and assuming that a noticeable amount of fading has occurred for the background picture, the actual color level of the background picture can be estimated and/or measured. For instance, the control 100 can estimate the current color level of the background picture 1200 based on the time that has elapsed since it was displayed, and based on known fading characteristics of the display device as determined from tests, for example. The estimated color level may account for factors other than time that may affect fading, such as the brightness setting of the display device, ambient lighting conditions, battery strength and the like. Fading can be measured, e.g., based on the reflectance of the display device. For instance, the acceptable threshold color difference may be based on a 3% change in reflectance. In one approach, the position of the sub-picture is not adjusted to avoid overlapping of like colors with the background picture, and the associated processing is not performed, when the elapsed time is so short that significant fading has not likely occurred in the background picture.

FIG. 12 shows an example background picture 1200 and an overlapping sub-picture 900. In this example, the current color level of the text 1210 of the background picture 1200 is a faded light grey. This color is sufficiently different from the initial black color level of the sub-picture 900 that it is acceptable for the sub-picture 900 to overlap the text 1210. That is, the respective color levels differ by more than the threshold. There is no need to separate the sub-picture 900 from the text 1210 since the fading of the text 1210 is not accentuated by the proximity of the sub-picture 900. The viewer perceives a stark difference in color that separates the sub-picture 900 from the text 1210. This approach is based on the fact that humans are less perceptive to a change in one color that is adjacent to a second color when the colors are disparate than when they are similar.

As an alternative to separating portions of the sub-picture 900 and background picture 800 having like colors, a transition region may be provided between the two pictures. For example, FIG. 13 illustrates an example background picture region 1300 with a faded black color level and an overlapping sub-picture region 1350 with an initial black color level. It will be appreciated that the regions 1300 and 1350 are representative, and that, in practice, a number of such regions can be defined in a display device. For instance, a number of such regions may follow the contour of the bear sub-picture 900 in FIG. 9. Moreover, the plural regions may be defined using any desired coordinate system, such as a Cartesian coordinate system or other system that is defined with respect to the display screen, or a localized coordinate system that is defined with respect to a feature in the background or sub-picture.

The background picture region 1300 is shown as being quite light for emphasis although in practice the difference between the two regions 1300 and 1350 is typically subtler. A transition region 1310 (FIG. 14) between the two regions 1300 and 1350 eases the abruptness of the transition between the regions 1300 and 1350 so that the transition is less visible, or not visible at all to the user. The transition region 1300 may have a color or greyscale level that is between the current color or greyscale level of the background region 1300 and the initial color or greyscale level of the sub-picture region 1350.

The control 100 can estimate the current color level of the background region 1300 based on the time that has elapsed since the background region 1300 was displayed and based on known fading characteristics of the display device as determined from tests, for example. The estimated color level may account for factors other than time that may affect fading, such as the brightness setting of the display device, battery strength, ambient lighting conditions, and the like. Another approach to determining fading is to measure the fading, e.g., based on the reflectance of the display device. For example, the control may estimate and/or measure that the faded black color of the background picture region 1300 corresponds to a specific grey level on a grey scale, e.g., level 12 of 16, where level 16 represents pure black, and level 0 represents pure white. Then, the control 100 can access data in the memory 120 indicating that the sub-picture region 1350 is pure black with a level of 16 in the present example, and provide the transition region 1310 with a grey level of 14, for instance, half way between 12 and 16. Note that the control may not provide the transition region 1310 unless the current color of the background picture region 1300 differs from the initial color of the sub-picture region 1350 by less than a threshold difference.

The transition region 1310 may extend into the background picture 1300 a given amount, such as five pixels. The size of the transition region 1310 may vary based on factors such as the size of features in the background picture and the size of the sub-picture, the display screen size and the like. The transition region 1310 may be provided by modifying the data of the background picture region 1300 in a look-up table (LUT) stored in the memory 120. The LUT stores data that defines how each pixel will be controlled. The data of the pixels in the transition region 1310. may be modified to provide the desired intermediate color.

In another approach, shown in FIG. 1S, a transition region 1320 between the sub-picture region 1350 and background picture region 1300 includes dithering or grey scaling. In particular, the edge between the sub-picture region 1350 and background picture region 1300 may be masked with a dithered or grey-scaled pattern to make the transition smoother. This approach requires more power consumption than providing a continuous color in the transition region. Dithering simulates shades of grey by altering the density and pattern of black and white dots. With grey scaling, each individual dot can have a different shade of grey. The data of the pixels in the transition region 1320 may be modified to provide the desired dots. The control may not provide the transition region 1320 unless the current visual characteristic, e.g., color, of the background picture region 1300 differs from the initial visual characteristic, e.g., color, of the sub-picture region 1350 by less than a threshold difference.

Generally, implementation of the invention may require an additional memory or capacity in the existing memory to store information regarding the color states of the background picture, the sub-picture positions and the transition region characteristics. Additionally, a modest additional amount of processor time may be needed to compare the data of the new sub-picture to the existing background picture and then define the position of the new picture in (x,y) coordinates.

Note that while color level/greyscale level has been mentioned as a visual characteristic of concern in providing a desirable positioning of a sub-picture over a background picture, or in providing a transition region between a sub-picture and background picture, other criteria such as brightness and contrast may be addressed as well using the techniques described herein. Moreover, while an example has been shown for positioning a single sub-picture over a background, the techniques discussed herein are applicable as well to positioning a number of sub-pictures over a background. In this case, each sub-picture can be optimally positioned individually. If the positioning of one sub-picture depends on the positioning of another, e.g., due to space constraints or other concerns, an optimization may be performed to arrive at the best compromise for the position of each sub-picture.

While there has been shown and described what are considered to be preferred embodiments of the invention, it will, of course, be understood that various modifications and changes in form or detail could readily be made without departing from the spirit of the invention. It is therefore intended that the invention not be limited to the exact forms described and illustrated, but should be construed to cover all modifications that may fall within the scope of the appended claims. The invention may, for example, be embodied in displays other than electronic reading devices, including inter alia, bill boards or other signage, in particular signage in which part of sign is “flashed” or changed rapidly while the rest of the sign remains unchanged

1. A method for displaying a sub-picture over a background picture on an electronic reading device, the method comprising:
determining a visual characteristic of at least a portion of the background picture (800, 810);
determining a visual characteristic of at least a portion of the sub-picture (900); and
determining a position for displaying the sub-picture (900) so that the at least a portion of the background picture (800, 810) and the at least a portion of the sub-picture (900) are separated when the visual characteristics thereof differ by less than a threshold difference.

2. The method of claim 1, wherein:
the visual characteristics comprise color levels.

3. The method of claim 1, wherein:
the visual characteristics comprise greyscale levels.

4. The method of claim 1, wherein:
the at least a portion of the background picture comprises information that is associated with information of the at least a portion of the sub-picture.

5. The method of claim 1, wherein:
determining the position for displaying the sub-picture comprises determining visual characteristics of different regions (1110) of the background picture until at least one of the regions is located whose visual characteristic differs from the visual characteristic of the at least a portion of the sub-picture by more than the threshold difference.

6. A display comprising:
at least one picture element (2) disposed on a display panel (1);
a control (100) comprising an addressing circuit (105) electrically connected to apply differences in electrical potential to the at least one picture element (2);
wherein the control (100) further comprises a computer program of instructions to cause the control (100) to determine a visual characteristic of at least a portion of a background picture (800, 810) and a visual characteristic of at least a portion of a sub-picture (900), and to determine a position for displaying the sub-picture (900) on the display panel (1) to separate the at least a portion of the background picture (800, 810) and the at least a portion of the sub-picture (900) when the visual characteristic thereof differ by less than a threshold difference; and
the control (100) being configured to cause the addressing circuit (105) to apply one or more of said differences in electrical potential to the at least one picture element (2) to display the sub-picture (900) in the determined position.

7. The display of claim 6, further comprising:
a memory (120) storing data indicating the visual characteristic of the at least a portion of the background picture;
wherein the control (100) further determines the position for displaying the sub-picture responsive to the data stored in the memory.

8. The display of claim 6, wherein the visual characteristics comprise color levels.

9. The display of claim 6, wherein the visual characteristics comprise greyscale levels.

10. The display of claim 6, wherein the at least one picture element (2) comprises an electrophoretic display.

11. An electronic reading device comprising the display of claim 6.

12. A sign comprising the display of claim 6.

13. The sign of claim 12 wherein the sub-picture (900) comprises a message or image which changes rapidly.

14. A method for displaying a sub-picture (1350) over a background picture (1300) on an electronic reading device, the method comprising:
determining a visual characteristic of at least a portion of the background picture (1300);
determining a visual characteristic of at least a portion of the sub-picture (1350); and
displaying the at least a portion of the sub-picture over the at least a portion of the background picture with a transition region (1310, 1320) therebetween in accordance with the visual characteristics thereof.

15. The method of claim 14, wherein:
the transition region has a visual characteristic that is between the visual characteristic of the at least a portion of the background picture and the visual characteristic of the at least a portion of the sub-picture.

16. The method of claim 14, further comprising:
estimating the visual characteristic of the at least a portion of the background picture.

17. The method of claim 14, further comprising:
measuring the visual characteristic of the at least a portion of the background picture.

18. The method of claim 14, wherein the transition region comprises one of a dithered and grey scaled pattern.

19. The method of claim 14, wherein the visual characteristics comprise at least one of color levels and greyscale levels.

20. The method of claim 14, wherein:
the at least a portion of the sub-picture is displayed over the at least a portion of the background picture when the visual characteristic of the at least a portion of the background picture differs from the visual characteristic of the at least a portion of the sub-picture region by less than a threshold difference.

21. A display comprising:
an array of picture elements (2) disposed on a display panel (1);
a control (100) comprising an addressing circuit (105) electrically connected to apply differences in electrical potential to the picture elements (2); and
wherein the control (100) further comprises a computer program configured to cause the control (100) to determine a visual characteristic of at least a portion of a background picture (1300) and a visual characteristic of at least a portion of a sub-picture (1350), and to determine a transition region between the at least a portion of the background picture (1300) and the at least a portion of the sub-picture (1350) according to the visual characteristics thereof, the control (100) being configured to cause the addressing circuit (105) to apply a set of said differences in electrical potential to a portion of the picture elements (2) to display the sub-picture (1350) with the determined transition region (1310, 1320).

22. An electronic reading device comprising the display of claim 21.

23. A sign comprising the display of claim 21.

24. The sign of claim 23 wherein the sub-picture (1350) comprises a message or image which changes rapidly.

25. A computer program product for displaying a sub-picture over a background picture on a bi-stable display, the computer program product comprising:
computer code devices configured to cause a computer to determine a visual characteristic of at least a portion of a background picture (1300) and a visual characteristic of at least a portion of a sub-picture (1350), and to display the at least a portion of the sub-picture (1350) over the at least a portion of the background picture (1300) in a position determined in accordance with the visual characteristics thereof or with a transition region (1310, 1320) between the at least a portion of the sub-picture (1350) over the at least a portion of the background picture (1300) determined in accordance with the visual characteristics thereof.
